(19) United States
(12) Patent Application Publication
(10) Pub. No.: US 2005/0273348 A1
(43) Pub. Date: Dec. 8, 2005

(54) Method and apparatus for assessing academic qualifications

(76) Inventor: Linda Brooks Rix, (US)

Correspondence Address: CROWELL & MORING LLP;INTELLECTUAL PROPERTY GROUP, P.O. BOX 14300, WASHINGTON, DC, 20044-4300, US

(21) Appl. No.: 10/861,912

(22) Filed: Jun. 7, 2004

(51) Int. Cl. G06F 17/60

(52) U.S. Cl. 705/1

(57) ABSTRACT

A system and method for assessing academic qualifications, wherein an electronic employment application includes a resume portion in which an applicant may identify their education history, and the resume portion provides a computerized listing of accredited educational institutions from which the applicant may select an institution to add to their employment application file, and a section for entry of information identifying educational institutions not included in the list of accredited educational institutions. If any applicant-identified educational institution not included in the list of accredited educational institutions, the application and/or the educational institution entry are automatically highlighted for further review.

### BACKGROUND OF THE INVENTION

The present invention relates to a method and apparatus for assessing, in an automated employment application environment, whether additional investigation into an applicant's educational history may be warranted.

In recent years, there has developed an increasingly wider-spread problem of applicants for employment in positions in government, business, academia and elsewhere, claiming to have obtained desired levels of education, where it is later learned that the degree-conferring institution was not accredited by a recognized accreditation authority.

As a result of this problem, an employer has no assurance that the now-employed applicant possesses the knowledge and skills expected of one who has completed a prescribed course of study at an accredited institution. Indeed, in some cases unaccredited institutions, often referred to as “diploma mills” are providing “degrees” with little or even no course work by the applicant. Unfortunately, it is often not until considerably later, in some cases years later, that the potentially deficient educational qualifications of the applicant (now employee) are discovered. Thus, by the time questionable or downright fraudulent educational experience claims are discovered, inadequate performance, and occasionally economic and other damages resulting from an applicant's lack of qualifications and knowledge, has already occurred.

The problem of inadequate knowledge and fraudulent education claims can be expected only to increase as more organizations turn to electronic and Internet-based processing of employment applications from position seekers. This is due in part to the shear volume of electronic resumes and job applications being received by organizations, which tends to overwhelm an organization's ability to review thoroughly the incoming resumes, and in part due to the proliferation of “diploma mills,” which makes accurate, up-to-date tracking of unaccredited institutions issuing inadequate or unjustified degrees difficult.

### SUMMARY OF THE INVENTION

In view of the foregoing problems, it is an objective of the present invention to highlight reliably potentially inadequate educational qualifications at the earliest possible stage during an electronic employment application process.

It is a further objective of the present invention to provide an automated approach to “flagging” for further review electronic employment applications listing educational institutions which potentially may not be accredited by a recognized accreditation authority.

An additional objective of the present invention is to provide a computer-based system including software which highlights potentially inadequate educational qualifications in an electronic employment application for further review.

The foregoing objectives are accomplished by providing a method and apparatus for assessing academic qualifications, in which employment application software executable on a computer for generating an electronic employment application includes a resume portion in which an applicant may identify his or her education history. The resume portion provides a hierarchically accessible computerized listing of accredited educational institutions (in one embodiment, sorted by geographic locale), from which the applicant may select an institution to add to the employment application file, and a section for entry of information identifying educational institutions not included in the list of accredited educational institutions. If any applicant-identified educational institution is not included in the list of accredited educational institutions, the application and/or the educational institution entry are automatically highlighted for further review.

The present invention thus provides an efficient, reliable approach to timely identification of potentially deficient education qualifications listed in résumés in electronically-submitted employment applications. Employers using electronic human resource management systems therefore are provided an opportunity at an early stage in the employment process to assess and verify the sufficiency of an applicant's knowledge and skills, and accordingly minimize the potential for subsequent economic and other damage resulting from the inadvertent hiring of an unqualified applicant.

Other objects, advantages and novel features of the present invention will become apparent from the following detailed description of the invention when considered in conjunction with the accompanying figures.

### BRIEF DESCRIPTION OF THE DRAWINGS

FIG. 1 is a schematic block diagram of a computer-based human resources management computer system in accordance with an illustrative embodiment of the present invention.

FIG. 2 is a process flowchart of an embodiment of an electronic employment application process used in conjunction with the system of the present invention shown in FIG. 1.

FIGS. 3-7 are illustrative Internet browser pages associated with the process flowchart of FIG. 2.

FIG. 8 is a process flowchart of an embodiment of an electronic employment application review process used in conjunction with the system of the present invention shown in FIG. 1.

FIGS. 9-12 are illustrative Internet browser pages associated with the process flowchart of FIG. 8.

### DETAILED DESCRIPTION OF THE DRAWINGS

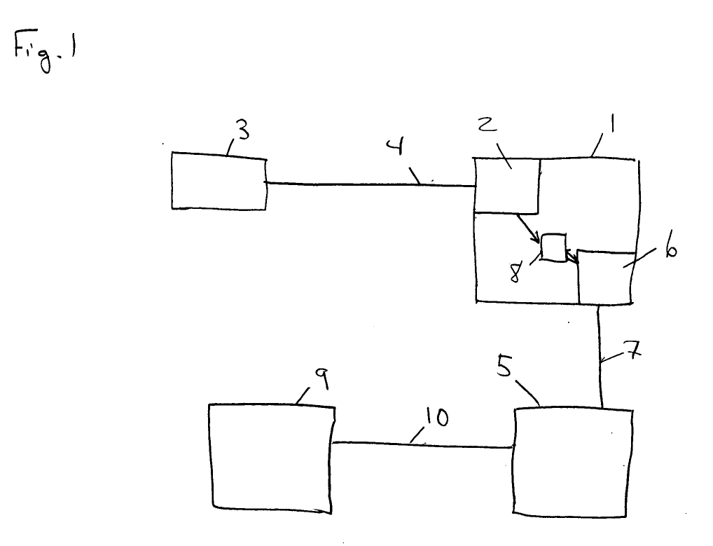

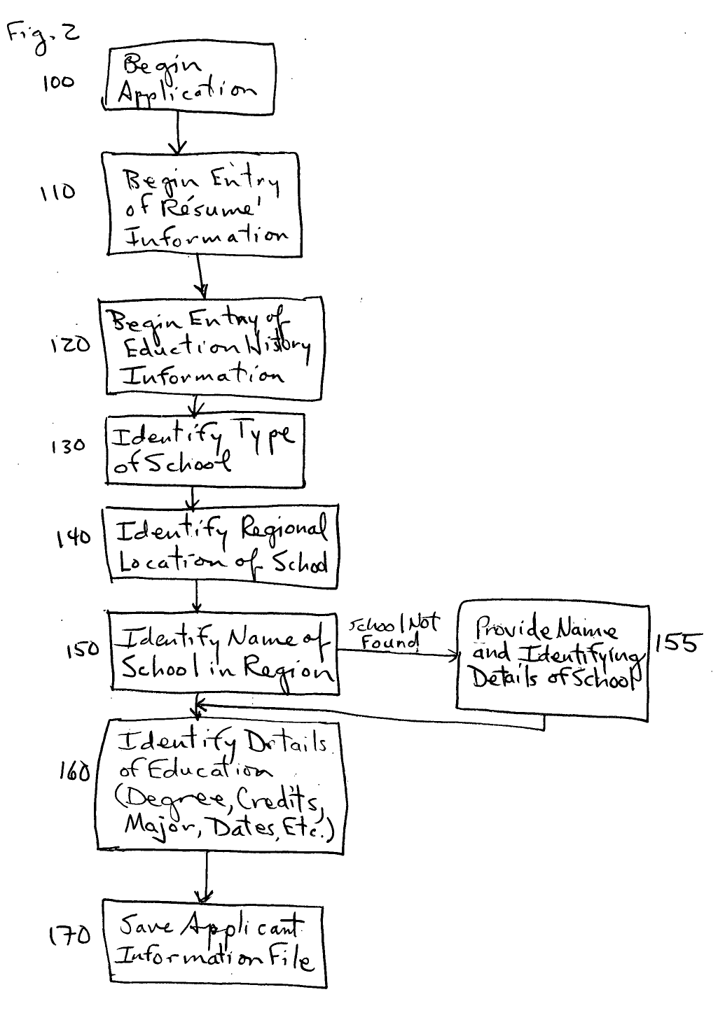

FIG. 1 illustrates a block diagram of a system embodying features of the present invention, centered on a human resources administration computer system 1, which may be a single computer or a network of computers. The human resources computer system executes software to provide delivery of digital human management resource services, such as the Avue Digital Services™ available from Avue Technologies, 1145 Broadway Plaza, Suite 800, Tacoma, Wash. 98402. The latter includes, inter alia, development of employment position descriptions and management of communications between employment applicants and employers, such as Federal government agencies and private companies. In the case of the Avue Digital Services, the software executed on the human resources computer system 1 is hosted on Avue's computer network, with appropriate portions of the software accessed by employment applicants and employers via the Internet. In the FIG. 1 embodiment, an employment applicant accesses an electronic employment application portion 2 on human resources computer system 1 from the applicant's computer 3 via a communications links, such as an Internet communications connection 4, with an Web browser such as Microsoft Corporation's Internet Explorer browser.

Similarly, a representative of the employer or its agent may access an employer-specific portion 6 of the software executed on the human resources computer system 1 from an employer computer 5 via another Internet or other communications connection 7 to develop and publish a position description for an employment opportunity, and to receive and evaluate applications for the position received from applicants. With respect to the latter function, the software executed on the human resources computer system 1 may receive information from an applicant (including résumé information) pertinent to one or more employment positions, and store the applicant information in an applicant information file 8. The applicant information file 8 may be retrieved and reviewed by the employer representative or their agent, for example, for review of the application to ascertain whether the applicant meets the minimum requirements for the position set by the employer. The employer representative or their agent may alternatively review and annotate or alter the application file 8 to place it in a form suitable for subsequent review by, for example, an employment decision maker 9 to whom the processed application file 8 is forwarded via an Internet or other network connection 10.

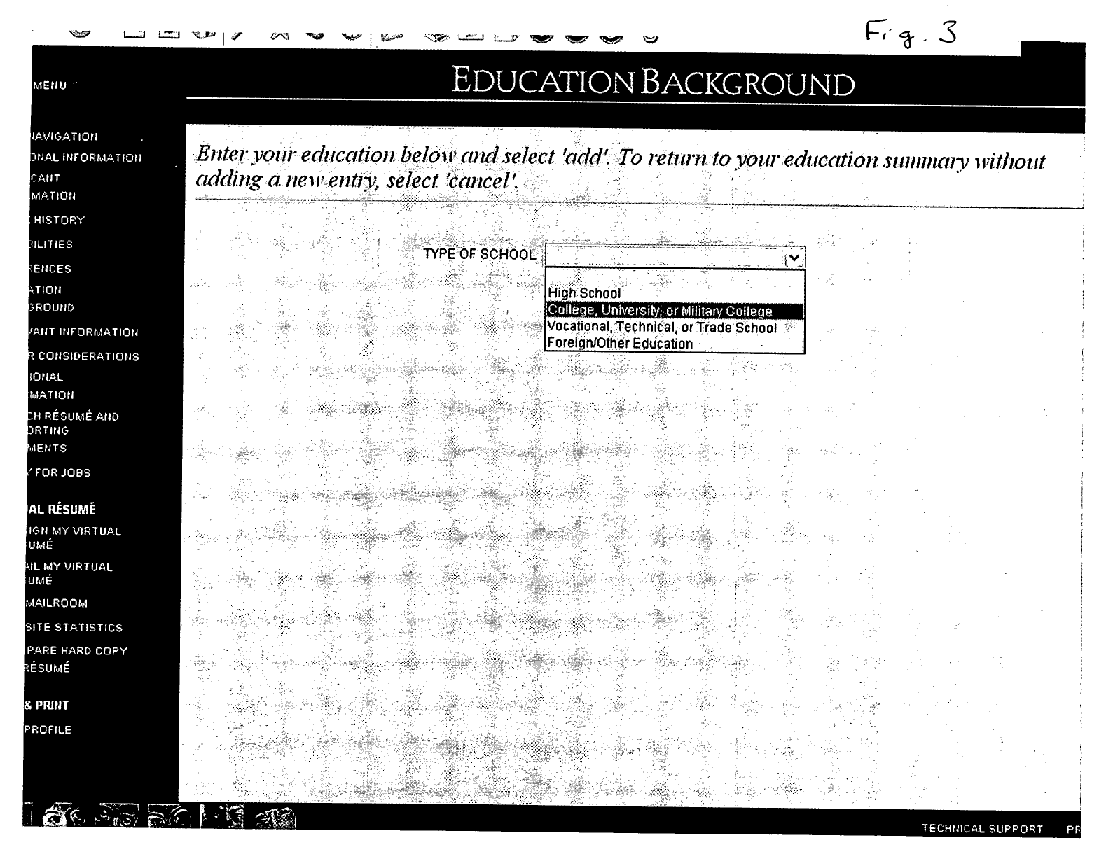

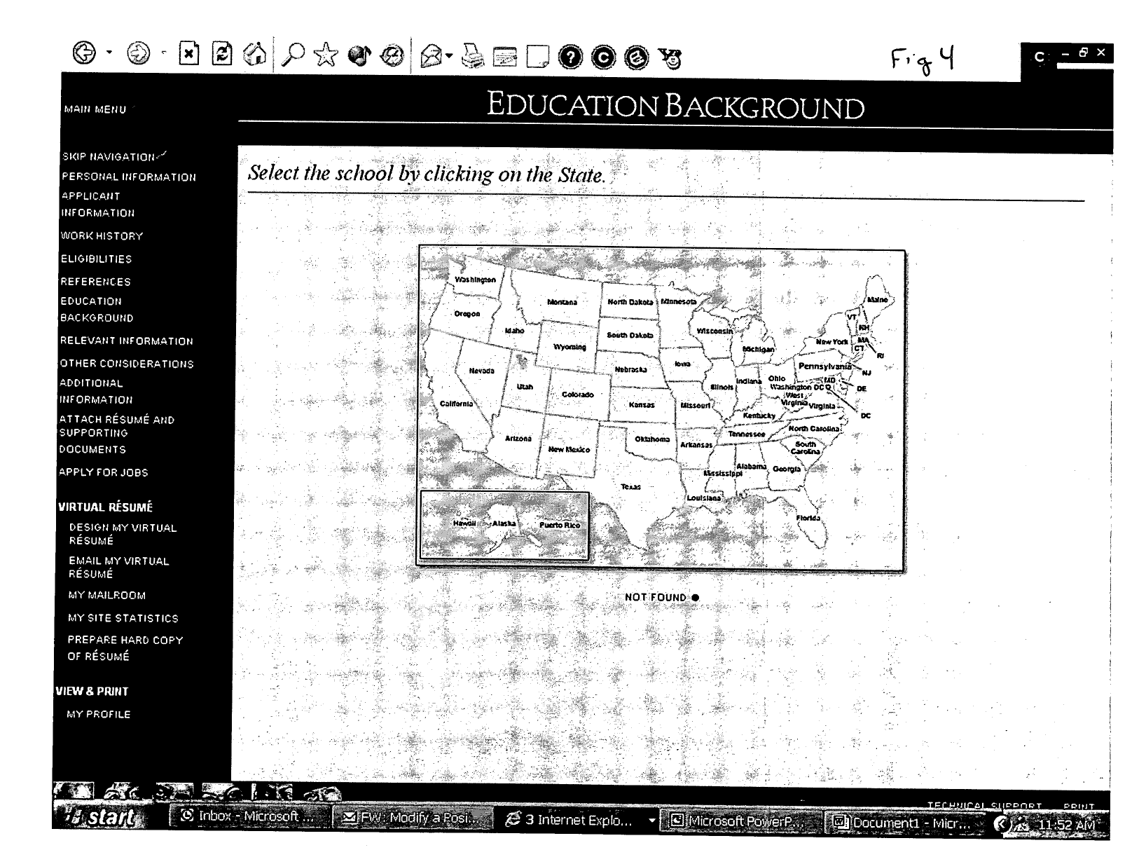

FIG. 2 is a process flowchart of the steps an employment applicant may perform in preparing an employment application to be used in conjunction with the method of the present invention and the system illustrated in FIG. 1. FIGS. 3-7 illustrate various Internet browser page views associated with the process steps of this preferred embodiment, as discussed further, below. At step 100, the applicant, having identified a desired employment opportunity, begins the employment application process by commencing an electronic employment application at applicant computer 3 via an Internet browser. At step 110, the applicant begins to enter résumé information.

As part of the applicant's résumé information entry, at step 120 the applicant begins to enter education history information, as shown in FIG. 3. If the applicant indicates that she or he has received educational credits or a degree beyond the secondary school level, at step 130 in the present embodiment, the applicant is presented with a list of types of schools from which the applicant may identify the nature of the education institution, in this case from a so-called “drop-down” list of school types included in the web page.

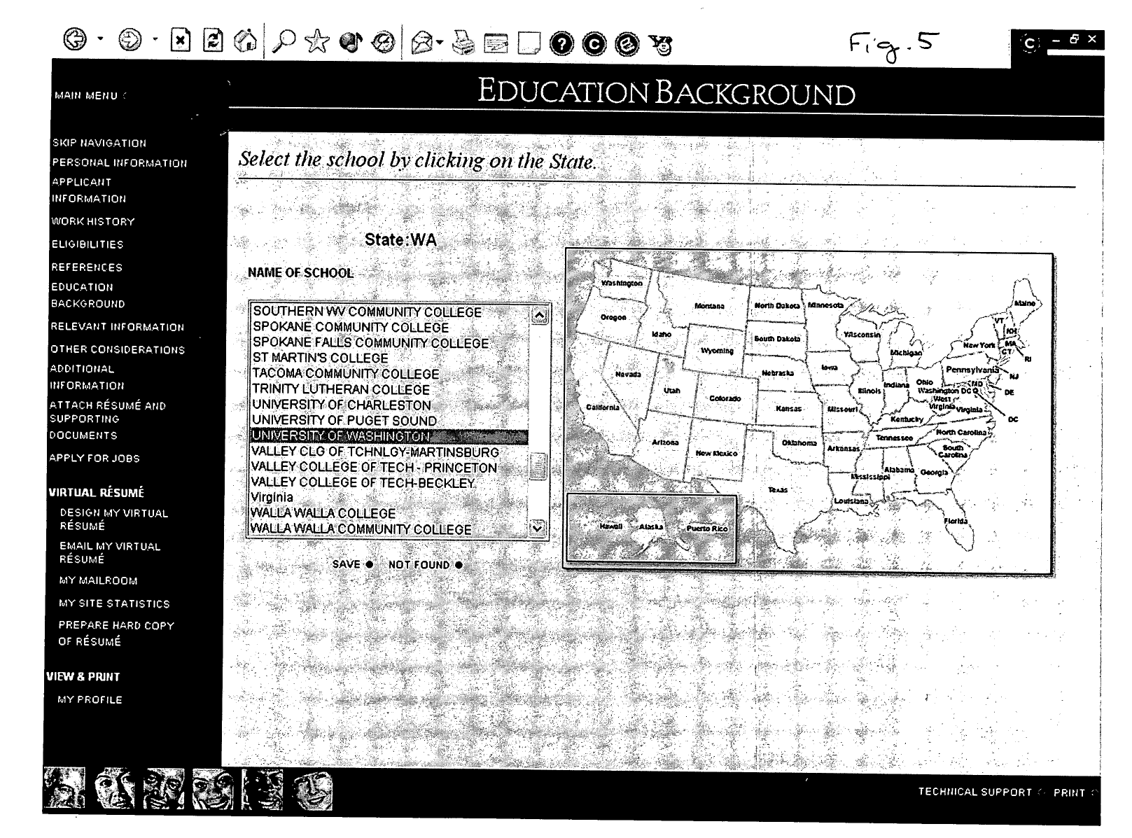

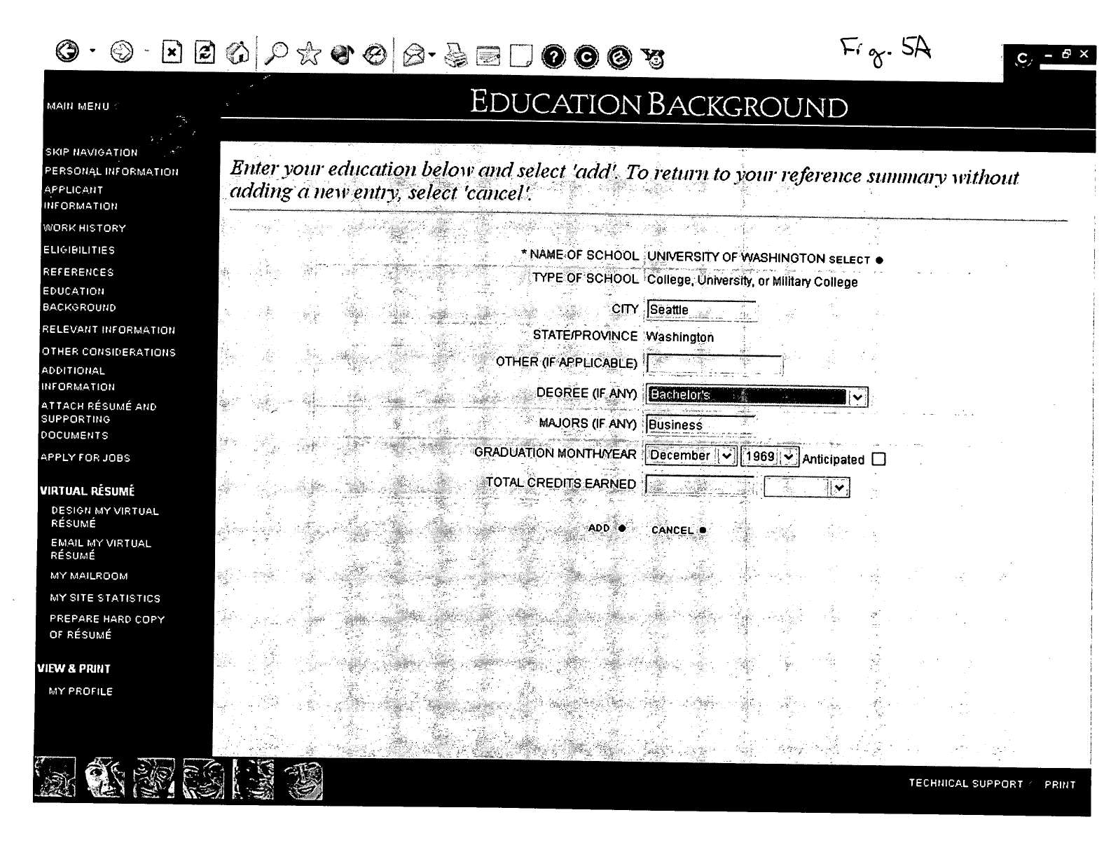

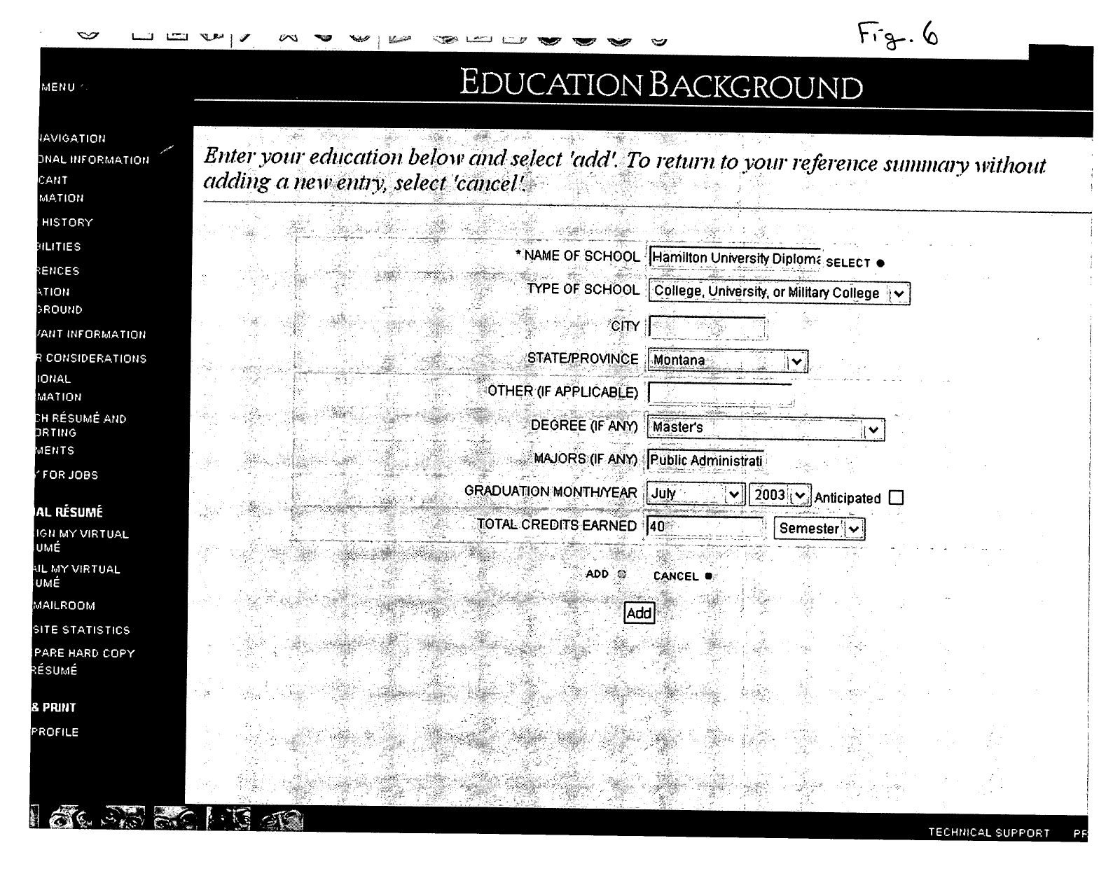

Once the applicant has selected the type of school he or she wants to add to the profile, they are taken to the next step in the accreditation verification process, identification of the geographic region of the school, step 140. In the present embodiment, the applicant is presented with a map of the United States as shown in FIG. 4, from which they can select a state or territory. In step 150, the applicant identifies the name of an educational institution. In the present embodiment, the applicant is presented with a listing of the names of accredited institutions in the selected geographic region and a “Not Found” choice as illustrated in FIG. 5. If the applicant selects a school from the listing, that school's name populates an education data entry profile, as shown in FIG. 5A. If the applicant's educational institution is not listed, they may select the “Not Found” selection, whereupon in step 155 they are permitted to manually enter the name and other identifying information for their educational institution in a web page such as that illustrated in FIG. 6.

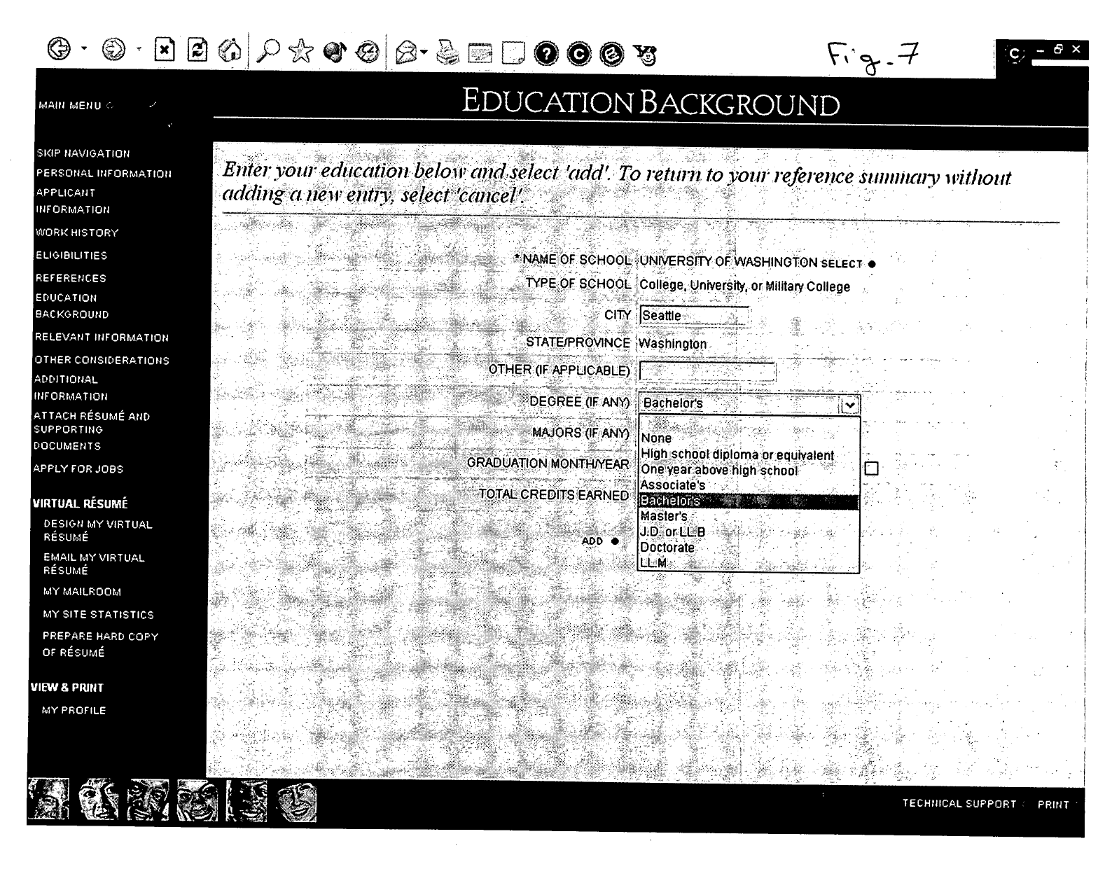

Next, at step 160, the applicant provides details of the education history entry, such as the type of degree or certification awarded, credits, academic major, dates of attendance, etc., as illustrated in FIG. 7. At step 170, the applicant's information is saved to their application information file 8 in human resources administration computer system 1. The applicant may also be provided the option of creating a “base profile” with the applicant's supplied information, such that his or her base profile is then available to be reused in multiple employment applications.

If the applicant has manually entered information identifying an educational institution which is not listed in the listing of the names of accredited institutions in the selected geographic region, the applicant's application is “flagged” with an indication that the educational institution's accreditation status is not determined.

Having provided an electronic employment application which an applicant has used to create an applicant information file 8, and having automatically highlighted any applicant-identified educational institution which is not listed in the listing of the names of accredited institutions, the present invention permits an accreditation verification review to proceed as follows.

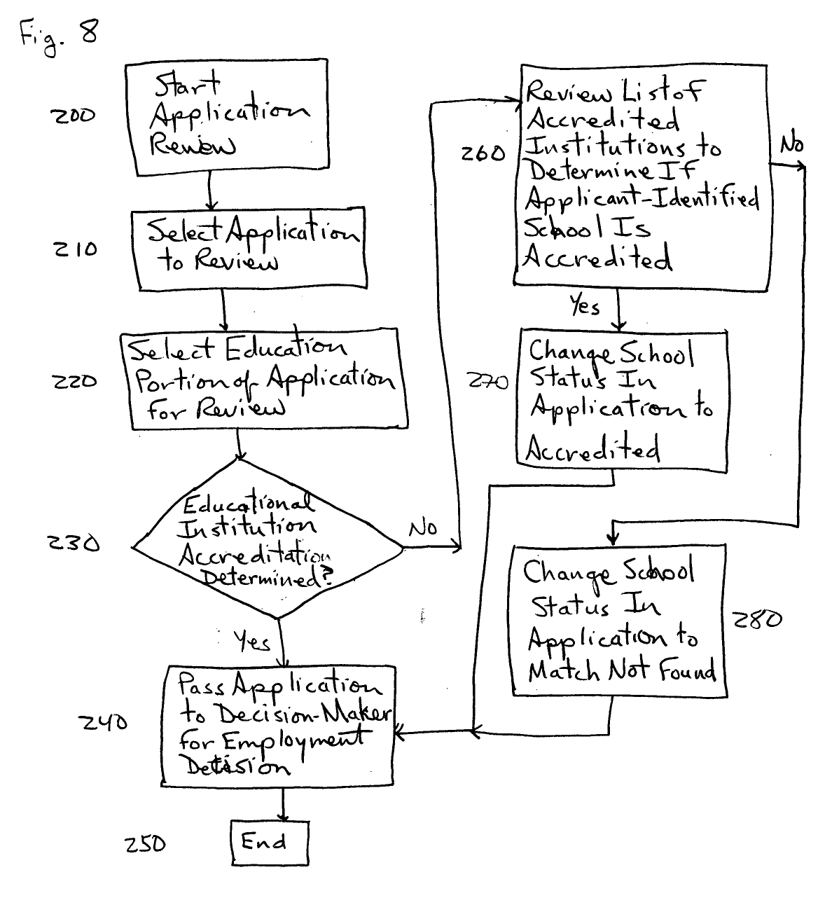

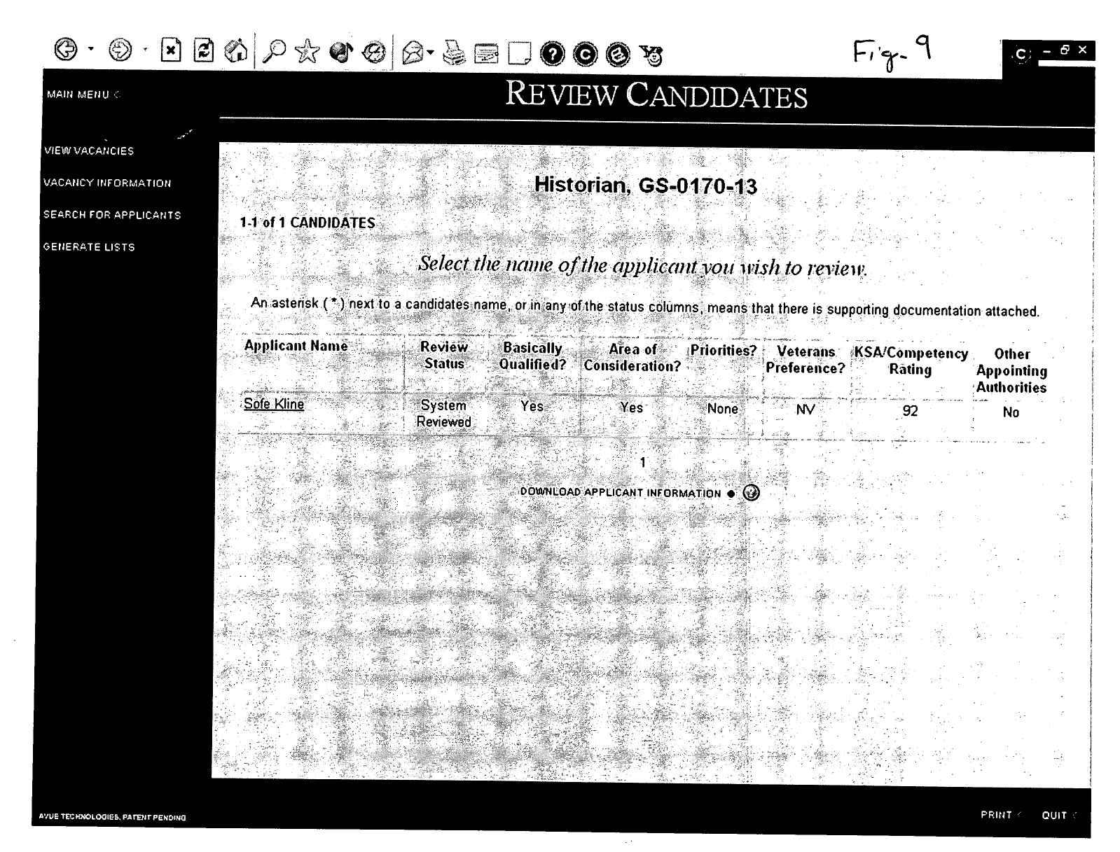

FIG. 8 is a process flowchart of an accreditation verification review process that may be performed by an employer's staffing specialist or administrative officer, for by an external person, such as a staff member of a party providing application review services to the employer (hereinafter, the “staffing specialist”). On starting the application review at step 200, at step 210 a staffing specialist using an Internet browser at employer computer 5 may access the employer-specific portion 6 of the software executed on the human resources computer system 1 to select an applicant information file 8 associated with a specific employment opportunity for review. FIG. 9 provides an example web page generated by the employer-specific software portion 6, in which a listing of applicants for a given employment position are listed. On selection, a summary of the applicant's employment application is presented to the staffing specialist.

Once the staffing specialist selects the flagged applicant's information file for review, the applicant's educational history or background may be selected for review in step 220. In step 230 the staffing specialist determines whether the educational institutions listed by the applicant are indicated to be accredited. If the institutions are identified as accredited, the staffing specialist may proceed to step 240 to pass the employment application to an employment decision-maker for further review, whereupon the staffing specialist's actions end at step 250.

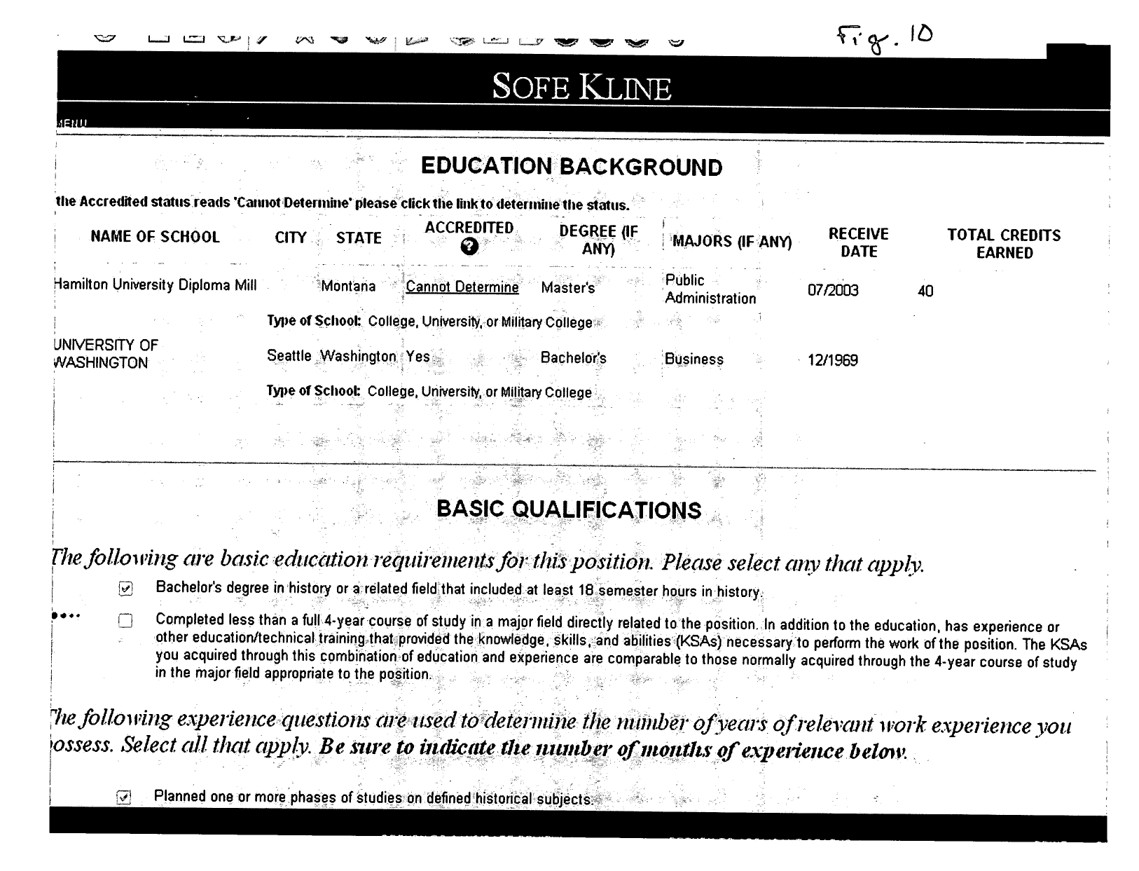

If, however, at step 230 the accreditation status of an applicant-identified educational institution is flagged as undetermined (in the example shown in FIG. 10, “Cannot Determine”), the staffing specialist proceeds to step 260.

At step 260, the staffing specialist may review a list of accredited educational institutions to determine whether an applicant-identified school is an accredited institution, for example, by using an automated school selection interface similar to that used by the applicant. If the applicant-identified educational institution is found to be accredited, at step 270 the staffing specialist may modify the applicant information file 8 to update the accreditation status of the applicant's educational institution prior to return to step 240 to forward the reviewed application to a decision-maker.

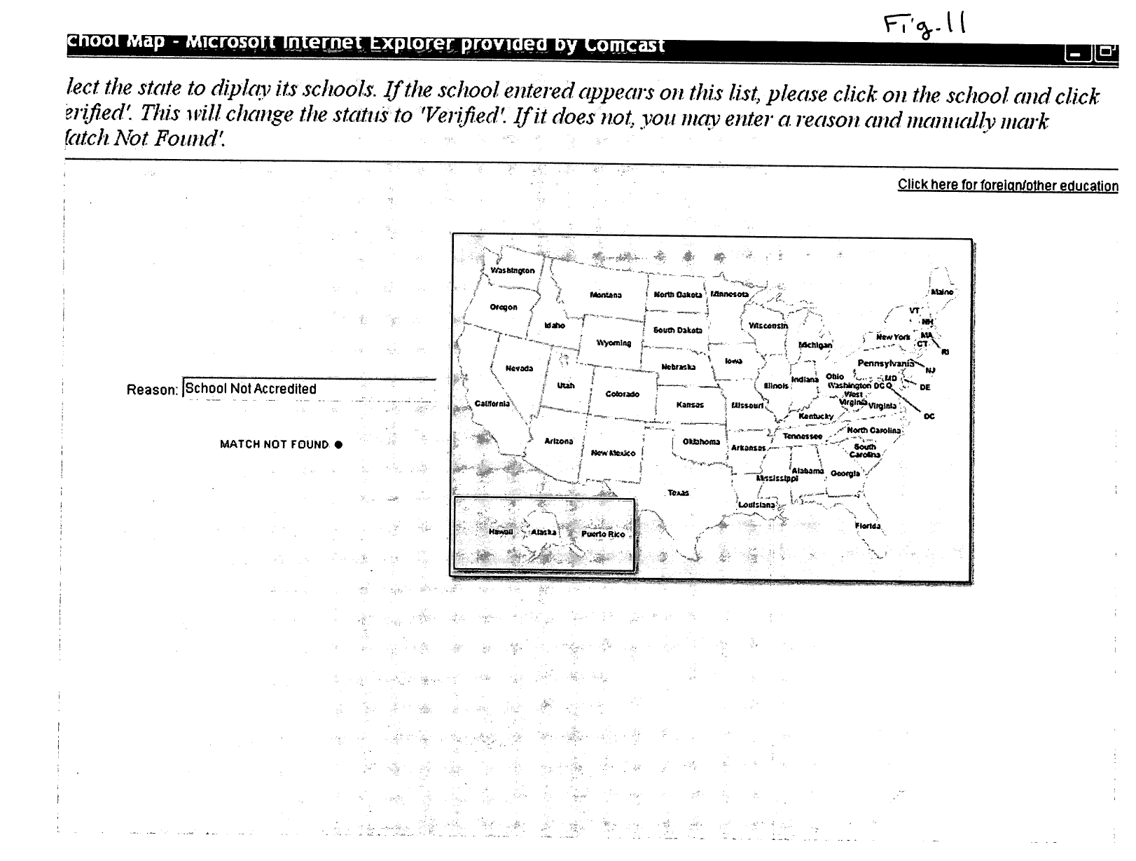

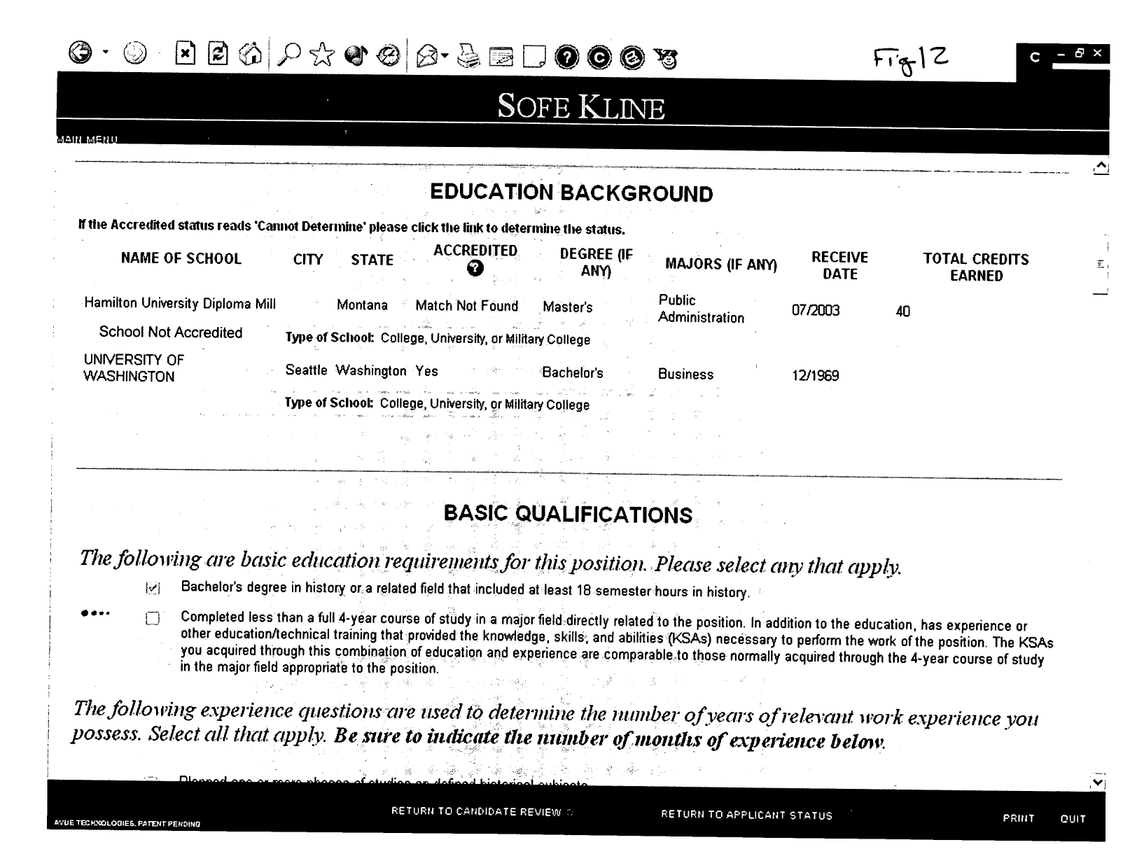

If after staffing specialist review, the institution can still not be found in a list of accredited schools, the staffing specialist can seek additional information from other information resources, Internet-based or otherwise. If no school accreditation is located, in step 280 the applicant information file 8 may be updated as shown in FIGS. 11 and 12 to reflect that the applicant-identified institution is not accredited or to provide a reason why the institution is not listed as accredited (for example, “Match Not Found” in FIG. 12). The staffing specialist may then proceed to step 240 to forward the reviewed application to a decision-maker.

The foregoing disclosure has been set forth merely to illustrate the invention and is not intended to be limiting. For example, rather than merely flagging an applicant-provided educational institution listing as having undetermined accreditation, the employment application software may further automatically perform the accreditation review search and verification steps performed by a staffing specialist in the foregoing embodiment by, for example, automatically obtaining and searching an updated listing of accredited educational institutions and updating the accreditation status information in the applicant's application file before forwarding the information in the file to an employment decision maker. Accordingly, since modifications of the disclosed embodiments incorporating the spirit and substance of the invention may occur to persons skilled in the art, the invention should be construed broadly to include everything within the scope of the appended claims and equivalents thereof.

1. A method for assessing academic qualifications, comprising the steps of:
providing an electronic employment application, wherein the employment application is generated by software executable on a computer for generating an employment application file;
presenting to the applicant in the electronic employment application a resume portion in which an applicant may identify their education history;
providing in said resume portion a computerized listing of educational institutions from which the applicant may select an institution to add to the employment application file;
further providing in said resume portion a section for entry of information identifying educational institutions not included in the list of educational institutions; and
highlighting automatically for review any applicant-identified educational institution not included in the list of educational institutions.

2. The method for assessing academic qualifications of claim 1, wherein the step of highlighting includes identifying an accreditation status of any applicant-identified educational institution not included in the list of educational institutions as accreditation undetermined.

3. The method for assessing academic qualifications of claim 2, further comprising the steps of:
reviewing the status of at least one applicant-identified educational institution not included in the list of educational institutions to determine whether the at least one educational institution is accredited; and
altering the accreditation status identification in the applicant's employment application file based on the results of the status review.

4. A system for assessing academic qualifications, comprising:
a computer; and
employment application software executable on the computer for generating an electronic employment application,
wherein the electronic employment application includes a resume portion in which an applicant may identify their education history, said resume portion providing
a computerized listing of educational institutions from which the applicant may select an institution to add to their employment application file, and
a section for entry of information identifying educational institutions not included in the list of educational institutions, and
wherein any applicant-identified educational institution not included in the list of educational institutions are automatically highlighted for human review.

5. The system for assessing academic qualifications of claim 4, wherein when the employment application software highlights for human review any applicant-identified educational institution not included in the list of educational institutions, accreditation status of any applicant-identified educational institution not included in the list of educational institutions is identified as accreditation undetermined.

6. The system for assessing academic qualifications of claim 5, wherein the employment application software permits the applicant's employment application file to be updated following review of at least one applicant-identified educational institution not included in the list of educational institutions to determine whether the at least one educational institution is accredited.

7. A method for processing academic qualification information in an electronic job application system, said method comprising the steps of:
providing a job applicant with an electronic employment application via a user interface;
said employment application providing said job applicant with a hierarchically accessible listing of educational institutions which are sorted according to predetermined criteria, as well as an additional field for entry of identification of educational institutions that are not included in said listing; and
highlighting automatically for review any applicant-identified educational institution not included in the list of educational institutions.

8. The method for processing academic qualification information of claim 7, wherein said step of providing a listing of accredited educational institutions comprises:
requesting that said job applicant enter information regarding a type of educational institution from which the applicant has received academic credit or a degree;
if the applicant indicates an educational institution of a type other than a secondary school, displaying a plurality of categories of academic institutions for the type indicated, sorted according to a predetermined criterion, for selection of a category by the applicant; and
upon selection of a category by the applicant, displaying a listing of educational institutions of the type indicated which are contained in the selected category, together with said additional field.

9. The method for processing academic qualification information of claim 8, wherein said predetermined criterion is based on geographic location.

10. The method for processing academic qualification information of claim 9, wherein
said step of displaying a plurality of categories comprises displaying a map of geographic subdivisions within a geographic area; and
said step of displaying a listing of educational institutions comprises displaying educational institutions of the type indicated by the applicant which are located within a selected geographic subdivision.

11. The method for processing academic qualification information of claim 10, wherein said map is a map which comprises at least states within the United States.

12. The method for processing academic qualification information of claim 11, wherein a state or other geographic subdivision is selected by an electronic selection device.

13. A system for processing academic qualification information in an electronic job application system, comprising:
a computer; and
employment application software executable on the computer for generating an electronic employment application,
wherein the electronic employment application includes a resume portion in which an applicant may identify their education history,
wherein said resume portion provides the applicant with hierarchically accessible listing of educational institutions which are sorted according to predetermined criteria, as well as an additional field for entry of identification of educational institutions that are not included in said listing, and
wherein any applicant-identified educational institution not included in the list of educational institutions are automatically highlighted for human review.

14. The system for processing academic qualification information of claim 13, wherein said resume portion
requests said job applicant enter information regarding a type of educational institution from which the applicant has received academic credit or a degree;
if the applicant indicates an educational institution of a type other than a secondary school, displays a plurality of categories of academic institutions for the type indicated, sorted according to a predetermined criterion, for selection of a category by the applicant; and
upon selection of a category by the applicant, displays a listing of educational institutions of the type indicated which are contained in the selected category, together with said additional field.

15. The system for processing academic qualification information of claim 14, wherein said predetermined criterion is based on geographic location.

16. The system for processing academic qualification information of claim 15, wherein
the display of the plurality of categories comprises display of a map of geographic subdivisions within a geographic area; and
the display of the listing of educational institutions comprises display of educational institutions of the type indicated by the applicant which are located within a selected geographic subdivision.

17. The system for processing academic qualification information of claim 16, wherein said map is a map which comprises at least states within the United States.

18. The system for processing academic qualification information of claim 17, further comprising an electronic selection device for selection of a state or other geographic subdivision.

19. The method for assessing academic qualifications of claim 1, wherein the computerized listing of educational institutions includes certification-issuing organizations.

20. The method for assessing academic qualifications of claim 19, wherein the certification-issuing organizations include at least one commercial business organization.

21. The system for assessing academic qualifications of claim 4, wherein the computerized listing of educational institutions includes certification-issuing organizations.

22. The method for assessing academic qualifications of claim 20, wherein the certification-issuing organizations include at least one commercial business organization.

23. The method for assessing academic qualifications of claim 7, wherein the hierarchically accessible listing of educational institutions, includes certification-issuing organizations.

24. The method for assessing academic qualifications of claim 23, wherein the certification-issuing organizations include at least one commercial business organization.

25. The system for assessing academic qualifications of claim 13, wherein the hierarchically accessible listing of educational institutions, includes certification-issuing organizations.

26. The method for assessing academic qualifications of claim 25, wherein the certification-issuing organizations include at least one commercial business organization.
